(19) United States
(12) Patent Application Publication
(10) Pub. No.: US 2025/0294304 A1
(43) Pub. Date: Sep. 18, 2025

(54) RENDERING OF VOLUMETRIC AUDIO ELEMENTS

(71) Applicant: Telefonaktiebolaget LM Ericsson (publ), Stockholm (SE)

(72) Inventors: Tommy FALK, SPÅNGA (SE); Eric SPERSCHNEIDER, EBERMANNSTADT (DE); Jonas SVEDBERG, UPPSALA (SE); Werner DE BRUIJN, UTRECHT (NL)

(73) Assignee: Telefonaktiebolaget LM Ericsson (publ), Stockholm (SE)

(21) Appl. No.: 18/857,633

(22) PCT Filed: Apr. 20, 2023
(86) PCT No.: PCT/EP2023/060298

§ 371 Date: Oct. 17, 2024

Related U.S. Application Data
(60) Provisional application No. 63/332,721, filed on Apr. 20, 2022.

(51) Int. Cl. H04S 7/00

(52) U.S. Cl. CPC H04S 7/30; H04S 2400/11; H04S 2400/13

(57) ABSTRACT

A method for rendering an audio element, such as a volumetric audio element comprising two or more audio signals. In one embodiment the method includes obtaining a distance gain model rendering parameter associated with the volumetric audio element. The method also includes, based on the value of the distance gain model rendering parameter, selecting a distance gain model from a set of two or more candidate distance gain models. The method also includes rendering the volumetric audio element using the selected distance gain model.

### TECHNICAL FIELD

Disclosed are embodiments related to rendering of volumetric audio elements.

### BACKGROUND

Spatial audio rendering is a process used for presenting audio within an extended reality (XR) scene (e.g., a virtual reality (VR), augmented reality (AR), or mixed reality (MR) scene) in order to give a listener the impression that sound is coming from physical sources within the scene at a certain position and having a certain non-zero size and shape (i.e., having a “spatial extent” or “extent” for short). The presentation can be made through headphone speakers or other speakers. If the presentation is made via headphone speakers, the processing used is called binaural rendering and uses spatial cues of human spatial hearing that make it possible to determine from which direction sounds are coming. The cues involve inter-aural time delay (ITD), inter-aural level difference (ILD), and/or spectral difference.

In real life we often perceive sound that is actually a sum of sound waves generated from many sound sources that are located on a certain surface or within a certain volume or area. Conceptually, one could consider such a surface, volume, or area to be a single audio element with a spatially heterogeneous character (i.e., an audio element that has a certain amount of spatial source variation within its spatial extent). A subclass of this are spatially heterogeneous audio elements for which the perceived heterogeneous spatial character does not change much along certain paths in the 3D space. Here are a few examples: 1) crowd sound (the sum of voice sounds from many individuals standing close to each other within a defined volume in space that reach the listener's two ears); 2) river sound (the sum of all water splattering sound waves emitted from the surface of a river that reach the listener's two ears); 3) beach sound (the sum of all the sound waves generated by ocean waves hitting the shore line of the beach that reach the listener's two ears; 4) water fountain sound (the sum of all the sound waves generated by water streams hitting the water surface of the fountain that reach the listener's two ears); and 5) busy highway sound (the sum of sounds from many cars that reach the listener's two ears).

In the case of a river sound, the perceived character of the sound will not change significantly for a listener that is walking alongside a river. This is equally true for a listener walking along the beach front or around a crowd of people.

Existing methods to represent these kinds of sounds include functionality for modifying the perceived size of a mono audio object, typically controlled by additional metadata (e.g., “size”, “spread”, or “diffuseness” parameters) associated with the object.

One such known method is to create multiple copies of a mono audio element at positions around the audio element. This arrangement creates the perception of a spatially homogeneous object with a certain size. This concept is used, for example, in the “object spread” and “object divergence” features of the MPEG-H 3D Audio standard (see reference [1] at 8.4.4.7 and 18.1), and in the “object divergence” feature of the EBU Audio Definition Model (ADM) standard (see reference [2] at 7.3.6).

This idea of using a mono audio source has been developed further as described in reference [3], where the area-volumetric geometry of a sound object is projected onto a sphere around the listener and the sound is rendered to the listener using a pair of head-related (HR) filters that is evaluated as the integral of all HR filters covering the geometric projection of the object on the sphere. For a spherical volumetric source this integral has an analytical solution. For an arbitrary area-volumetric source geometry, however, the integral is evaluated by sampling the projected source surface on the sphere using what is called a Monte Carlo ray sampling.

Another rendering method renders a spatially diffuse component in addition to a mono audio signal, which creates the perception of a somewhat diffuse object that, in contrast to the original mono audio element, has no distinct pin-point location. This concept is used, for example, in the “object diffuseness” feature of the MPEG-H 3D Audio standard (see reference [3]) and the “object diffuseness” feature of the EBU ADM (see reference [2] at 7.4).

Combinations of the above two methods are also known. For example, the “object extent” feature of the EBU ADM combines the creation of multiple copies of a mono audio element with the addition of diffuse components (see reference [2] at 7.3.7).

### SUMMARY

Certain challenges presently exist. For example, in cases where a volumetric audio element (i.e., an audio element with an extent) represents so many individual sources that the individual sources essentially behave as one large compound source, the rendering of the audio element can be based on a volumetric behavior where, for example, the distance gain (i.e., the relative level of the rendered audio element as a function of listening distance) is calculated based on the size of its extent; but if the volumetric audio element represents sound sources that, due to their spatial distribution over the audio element, would be expected to behave as individual sources, with their own specific position within the extent of the audio element, then the expected behavior is that of a collection of point-sources where the distance gain function follows the inverse distance law, 1/r. Thus, this choice of gain function depends on the specific audio element and what kind of sound source it is representing.

In some cases, a content creator can decide what the desired rendering behavior should be applied by explicitly setting rendering parameters of the metadata of the audio element that controls this. In other cases, it is preferable that the renderer automatically chooses the most suitable rendering parameters for the audio element, or that a pre-processing step can set the parameters so that the suitable gain function is used by the renderer. Currently, however, there are no such automatic rendering methods available.

Accordingly, in one aspect there is provided a method for rendering an audio element, such as a volumetric audio element comprising two or more audio signals. In one embodiment the method includes obtaining a distance gain model rendering parameter associated with the volumetric audio element. The method also includes, based on the value of the distance gain model rendering parameter, selecting a distance gain model from a set of two or more candidate distance gain models. The method also includes rendering the volumetric audio element using the selected distance gain model.

In another embodiment the method includes obtaining a spatial audio value, S, for the audio element (e.g. a volumetric audio element), wherein S indicates a spatial audio density of the volumetric audio element. The method also includes selecting one or more rendering options for the volumetric audio element based on the obtained spatial audio value. The method further includes rendering the volumetric audio element using the selected rendering option(s).

In another aspect there is provided a method performed by an encoder. The method includes obtaining a spatial audio value, S, for a volumetric audio element, wherein S indicates a spatial audio density of the audio element. The method also includes at least one of the following two steps: (1) selecting one or more rendering options for the volumetric audio element based on the obtained spatial audio value or (2) processing metadata for the volumetric audio element (e.g., storing the metadata, transmitting the metadata, etc.), wherein the metadata comprises at least one of the following: i) information identifying the selected rendering option(s) and/or ii) the spatial audio value.

In another aspect there is provided a computer program comprising instructions which when executed by processing circuitry of a apparatus causes the apparatus to perform any of the methods described herein. In one embodiment, there is provided a carrier containing the computer program, wherein the carrier is one of an electronic signal, an optical signal, a radio signal, and a computer readable storage medium. In another aspect there is provided an apparatus that is configured to perform any of the methods described herein. The apparatus may include memory and processing circuitry coupled to the memory.

An advantage of the embodiments disclosed herein is that they make it possible to automatically select a suitable rendering behavior (e.g., gain function) for an audio element depending on spatial characteristics of the audio signals representing the audio element. The analysis step of the method can either be done at runtime within the renderer or as a pre-processing step before the runtime rendering.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a flowchart illustrating a process according to some embodiments.

FIG. 3 is a flowchart illustrating a process according to some embodiments.

FIGS. 4A and 4B show a system according to some embodiments.

FIG. 5 illustrates a system according to some embodiments.

FIG. 6. illustrates a signal modifier according to an embodiment.

FIG. 7 is a block diagram of an apparatus according to some embodiments.

FIG. 8 is a flowchart illustrating a process according to some embodiments.

### DETAILED DESCRIPTION

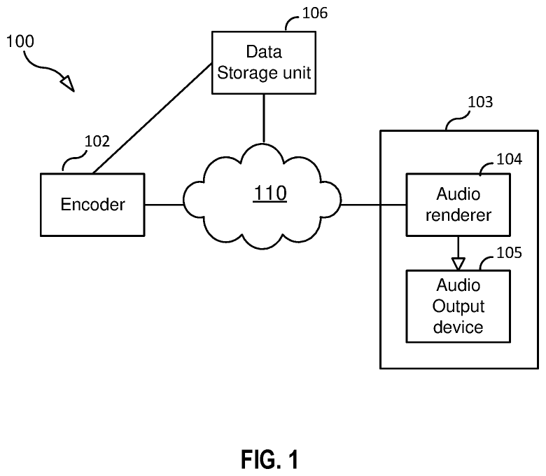

FIG. 1 illustrates a system 100 according to one embodiment. System 100 includes an encoder 102 and an audio renderer 104 (or renderer 104 for short), wherein encoder 102 may be in communication with renderer 104 via a network 110 (e.g., the Internet or other network) (it is also possible that the encoder and renderer are co-located or implemented in the same computing device). In one embodiment, encoder 102 generates a bitstream comprising an audio signal and metadata and provides the bitstream to renderer 104 (e.g., transmits the bitstream via network 110). In some embodiments, rather than providing the bitstream directly to renderer 104, the bitstream is stored in a data storage unit 106 and renderer retrieves the bitstream from data storage unit 106. Renderer 104 may be part of a device 103 (e.g., smartphone, TV, computer, XR device) having an audio output device 105 (e.g., one or more speakers).

This disclosure proposes, among other things, selecting rendering options (e.g., selecting a particular distance gain model) to use in the process of rendering the audio signal for a volumetric audio element (i.e., an audio element having a spatial extent) by determining a spatial audio value(S) for the audio element and selecting suitable rendering options for the audio element based on S. For example, an encoder may select a particular distance gain model to use in the rendering of the volumetric audio element by, based on the value of S, setting a “distanceGainModel” rendering parameter for the volumetric audio element to a particular value that identifies the particular distance gain model (e.g., if S>threshold, then distanceGainModel=1, otherwise distanceGainModel=0). In one embodiment, S is determined by analyzing the audio element's audio signals and measuring a level of spatial sparsity (or spatial density) of the audio signals.

### Introduction

Some aspects of the rendering of a volumetric audio element are based on certain assumptions about the spatial character of the audio element. An example of this is the modelling of the distance gain, which may be based on one of three main idealized models:
1) Point source, where the sound propagation from the source is modelled as spherical propagation in all directions from one point. An example could be the sound of a bird;
2) Line source, where the sound propagation is modelled as cylindrical propagation from a line-shaped object (e.g., the sound of a train); and
3) Plane source, where the sound propagation is modelled as plane waves (e.g., a waterfall that is both wide and high).

In reality, volumetric audio elements rarely, if ever, have the exact distance gain behavior of any of these three “prototype” sources. International patent application WO2021/121698 describes a more realistic model for the distance gain of a volumetric audio element that, based on the dimensions of the audio element, derives the physically correct distance gain at any given distance from a volumetric audio element of the given size. This model will be referred to further as the “volumetric distance gain model.”

The line, plane and volumetric source models are based on the assumption that the sound source can be regarded as an infinite set of evenly distributed point sources, i.e., that the source is continuous. But if the sound signals of an audio element represent a recording of a single point-source or a few point-sources that are sparsely distributed over a line or plane, this assumption will not be valid. In this case the audio element should be rendered using the point source sound propagation model, even if the audio element has a big extent.

Another rendering aspect of volumetric sources that may be affected by the extent to which the “continuous source” assumption holds, is the aspect of “Effective Spatial Extent” described in International patent application no. WO2022/017594, which describes a method for determining, based on the source's dimensions, the acoustically relevant part of a volumetric source for a listener at a given listening distance relative to the source, using the continuous-source assumption, and the effective size of the source that is used in the rendering is modified accordingly. Here, in case the audio element consists of a sparse rather than continuous source distribution, it may not be appropriate to apply the modification of the effective extent size.

WO2021/121698 describes the use of metadata that instructs the renderer whether it should render a volumetric audio element using a volumetric distance gain model based on the audio element's dimensions, or that it should instead render the source using a point source distance gain.

As described herein, the abovementioned metadata described in WO2021/121698 for controlling the distance gain behavior of a volumetric audio element may be selected based on a spatial audio value (e.g., spatial sparsity value or spatial density value) for the volumetric audio element, which may be determined as described in more detail below.

WO2022/017594 describes metadata that instructs the renderer whether to use the described effective spatial extent model for a volumetric source or not, depending, e.g., on whether the volumetric source radiates sound from its full extent or is merely a conceptual volume that contains a limited number of individual sound sources. The abovementioned metadata described in WO2022/017594 for controlling the effective spatial extent for a volumetric audio element may be selected based on the spatial audio value for the volumetric audio element.

### Definition of Spatial Density/Sparsity

The spatial density (or its inverse, spatial sparsity) of an audio signal describes the extent to which the sound energy of the audio signal is evenly distributed, including both the spatial distribution and the time distribution. An audio signal that represents a recording of a single point source has a low spatial density; similarly, an audio signal that represents a recording of several point sources that are only active one at a time also has a low spatial density. In contrast, an audio signal that represents a recording of a multitude of sound sources where it is difficult to perceive the individual sources has a high spatial density.

As an example, a recording of one person clapping hands represents a signal with low spatial density. A recording of a group of people that clap their hands one at a time also represents a signal with low spatial density. But a recording of a large group of people clapping their hands continuously represents a signal with high spatial density.

The spatial density measure is not a binary measure, but rather a continuum between spatially sparse and spatially dense. Many sounds will reside in the middle, being somewhere in-between the extreme points.

In one embodiment, the decision of what rendering options to use for rendering a given volumetric audio element is based on a binary decision where a threshold is used to decide between what audio elements should be seen as spatially dense and which should be seen as spatially sparse. In another embodiment there is no binary decision, but the spatial audio value (e.g., spatial sparsity/density measure) is used as a weighting factor that makes it possible to smoothly go from one rendering behavior representing the spatially sparse signals to another rendering behavior representing the spatially dense signals.

### Pre-Processing Implementation

In one embodiment, encoder 102 receives a volumetric audio element (more specifically, encoder receives metadata that describes the volumetric audio element plus the multi-channel audio signal that represents the audio element). The volumetric audio element may be an MPEG-I Immersive Audio element of the type ObjectSource, with a “signal” attribute that identifies the multi-channel signal corresponding to the audio element, an “extent” attribute that identifies a geometry data element that represent the spatial extent of the audio element, along with other attributes that, for example, indicate the position, orientation, and gain of the audio element.

Encoder 102 then derives a spatial audio value, S, for the audio element (e.g., a spatial sparsity value). Based on the spatial audio value, encoder 102 selects one or more rendering options (e.g. a distance gain model). For example, encoder 102 may select a distance gain model from a set of two or more candidate distance gain models by setting a distance gain model rendering parameter (denoted “distanceGainModel”) that indicates that a specific one of several distance gain models should be used for the audio element. The distance gain model rendering parameter may be a Boolean parameter (flag) that indicates whether a certain specific distance gain model (e.g., a volumetric distance gain model), should be applied when rendering the audio element, or that another certain specific distance gain model (for example a point source distance gain model) should be applied. Alternatively, the distance gain model rendering parameter may have a value that identifies one out of multiple distance gain models.

Encoder then inserts into the metadata for the audio element and/or bitstream carrying the audio element (for example, an MPEG-I Immersive Audio bitstream) the rendering parameters that were set based on S. Table 1 below illustrates metadata for each audio element where the distance gain model rendering parameter named “distanceGainModel” is a Boolean flag (i.e., 1 bit).

TABLE 1

| | No. of | |
|---|---|---|
| Syntax | bits | Mnemonic |
| payloadAudioPlus( ) | | |
| { | | |
| numberOfSources; | 8 | uimsbf |
| for (int i = 0; i < numberOfSources; i++){ | | |
| audioSourceId; | 16 | uimsbf |
| distanceGainModel; | 1 | bslbf |
| hasDiffuseness; | 1 | bslbf |
| if (hasDiffuseness) { | | |
| diffuseness; | 7 | uimsbf |
| } | | |
| } | | |
| } | | |

A renderer then receives the audio element and the distance gain model rendering parameter (e.g., it receives the bitstream containing the audio signal for the audio element and the accompanying metadata containing the distance gain model rendering parameter and extent information) and renders the audio element using the distance gain model indicated by the distance gain model rendering parameter.

In another embodiment, rather than selecting a rendering option based on the spatial audio value, encoder 102 simply includes the spatial audio value, S, in the metadata for the audio element, and the renderer, after receiving the spatial audio value, selects one or more rendering options (e.g., a distance gain model) based on the spatial audio value.

As noted above, encoder 102 selects one or more rendering options based on the spatial audio value. Accordingly, in addition to (or instead of) selecting a distance gain model, encoder 102 may use the spatial audio value, S, for selecting other rendering options (e.g., for configuring or controlling other rendering aspects of the volumetric source).

For example, the spatial audio value may be used to decide whether a renderer should apply a model for modifying the effective spatial extent when rendering the audio element or not. As in the example of the distance gain models above, the encoder may either derive a Boolean rendering parameter that instructs the renderer whether to apply the effective spatial extent model or not, or it may directly transmit the spatial audio value in which case the renderer makes the decision based on the spatial audio value.

In some embodiments, rather than encoder 102 determining the spatial audio value, renderer 104 may determine the spatial audio value and then selects one or more rendering options based on the spatial audio value. Moreover, any device external to both encoder 102 and renderer 104 may be configured to calculate the spatial audio value (or assist in the calculation thereof).

### Calculating the Spatial Audio Value(S)

In one embodiment, a first step in the calculation of S for an audio element is to filter the audio signal (X[nC, nT]) for the audio element using a filter (e.g., a high-pass filter), where nC is the number of audio channels that the audio signal contains and nT is the number of samples in each audio channel, to produce a filtered audio signal (X′[c,t]).

In one embodiment,

$${X}^{′} [ c , t ] = {\sum }_{n = 0}^{L - 1} X [ c , t + n ] * h [ n ] \qquad ( Equation 1 )$$

where X′[c, t] is the resulting h(n) filtered multichannel audio signal over channel c and time t, and L is the filter length and h[n] are the filter coefficients.

The high-pass filter (h[n] above in Equation (1)) enables a directivity and sparsity analysis in a domain representing subjective loudness better than in an unfiltered domain.

Through experimentation it was found that a filter with a −3 dB point of 1478 Hz and a −6 dB point at 1000 Hz was suitable as a pre-processing high-pass filter (h[n]), however other high-pass filter designs can also be employed for as a subjectively motivated pre-processing high-pass filter: e.g. using 3 dB design point in the range=[400Hz-2 kHz].

Table 2 below shows an example Frequency response of h (n):

h[n] = [
−2.921834619927504e−04 −6.398604313745266e−04 −1.189207052206282e−03
−1.989790939845475e−03 −3.087568654398166e−03 −4.520632696700337e−03
−6.314933878299575e−03 −8.480346419199848e−03 −1.100744894382348e−02
−1.386536567127730e−02 −1.700094897200851e−02 −2.033949099184969e−02
−2.378703535585882e−02 −2.723422983138956e−02 −3.056152878694657e−02
−3.364543252969662e−02 −3.636535080324513e−02 −3.861060982537994e−02
−4.028709343867147e−02 −4.132302290183649e−02 9.584890342178020e−01
−4.132302290183649e−02 −4.028709343867147e−02 −3.861060982537994e−02
−3.636535080324513e−02 −3.364543252969662e−02 −3.056152878694657e−02
−2.723422983138956e−02 −2.378703535585882e−02 −2.033949099184969e−02
−1.700094897200851e−02 −1.386536567127730e−02 −1.100744894382348e−02
−8.480346419199848e−03 −6.314933878299575e−03 −4.520632696700337e−03
−3.087568654398166e−03 −1.989790939845475e−03 −1.189207052206282e−03
−6.398604313745266e−04 −2.921834619927504e−04];

This specific filter was designed in Matlab™ using Fd=1000; N=40; Fd_norm=Fd/(48000/2); beta=5.0; % FIR filter design using Kaiser window h[n]=fir1(N,Fd_norm, ‘high’, kaiser(N+1,beta)).

The filtered audio signal is then divided into frames according to equation 2:

$${x}_{i} [ c , t ] = {X}^{′} [ c , i * F + t ] ; t ∈ [ 0 , … , F - 1 ] \qquad ( Equation 2 )$$

were F is the frame length and i is the frame number.

An example frame length F is 100 ms corresponding to F=4800 samples at a sampling frequency of 48 KHz.

The average energy per frame i, across all channels c is calculated to be used for a final normalization of the sparsity measure, and is calculated as:

$${energy}_{i} = \frac{1}{n C} \frac{1}{F} {\sum }_{c = 0}^{n C - 1} {\sum }_{t = 0}^{F - 1} {{x}_{i} [ c , t ]}^{2} \qquad ( Equation 3 )$$

Spatial analysis and directionality ratio:

For each frame i a Singular Value Decomposition (SVD) analysis is performed. SVD is a known method to decompose a signal into Matrix U, diagonal matrix Σ with diagonal D, and a matrix V^{T}. That is, SVD is a technique to decompose a matrix into a set of several component matrices, and may be used to expose interesting properties of the original matrix.

$$X = U \sum {V}^{T} , \qquad ( Equation 4 )$$

(here xᵢ above is matrix X, for frame i).

$${D}_{j} = [ {\sum }_{1 , 1} , {\sum }_{2 , 2} , … {\sum }_{Nc , Nc} , ] \qquad ( Equation 5 )$$

Calculating the SVD consists of finding the eigenvalues and eigenvectors of XX^{T} and X^{T}X The eigenvectors of X^{T}X make up the columns of V, the eigenvectors of XX^{T} make up the columns of U. Also, the singular values in Σ are square roots of eigenvalues from XX^{T} or X^{T}X. The singular values are the diagonal entries of the Σ matrix and are typically) arranged in descending order. The singular values are always real numbers. If the input matrix X is a real matrix, then U and V are also real.

In python (v 3.8.2, module numpy.linalg) SVD analysis of can accomplished by: D=numpy.linalg.svd (X, full_matrices=False, compute_uv=False). In Matlab™ version R2018b, Singular Value Decomposition analysis can be accomplished by: D=svd(X).

For each frame i a relation between the extreme diagonal elements is calculated as:

$$di {r}_{i} = \frac{{max}_{j} {D}_{j}}{{min}_{j} {D}_{j}} \qquad ( Equation 6 )$$

$${dirDB}_{i} = 10 * log 10 ( d i {r}_{i} ) \qquad ( Equation 7 )$$

dirᵢ is a measure of the directional dynamics of the multichannel signal X, dirᵢ will typically have a range of [1.0 . . . 12.0]. The directionality ratio dirᵢ can been seen as the strength relation between the principal axis and the most diffuse (and weak) axis.

A Mid-Side relation per frame i is calculated as:

$$m i {d}_{i} [ t ] = \frac{1}{n C} {\sum }_{c = 0}^{n C - 1} {x}_{i} [ c , t ] \qquad ( Equation 8 )$$

$${side}_{i} [ c , t ] = \{ \begin{matrix}{x}_{i} [ 0 , t ] - {x}_{i} [ 1 , t ] ; c = 0 , & if nC = 2 \\ {x}_{i} [ c , t ] - m i {d}_{i} [ t ] : c = 0 … nC - 1 , & if nC > 2\end{matrix} \qquad ( Equation 9 )$$

$$eMi {d}_{i} = \frac{1}{F} {\sum }_{t = 0}^{F - 1} {{mid}_{i} [ t ]}^{2} \qquad ( Equation 10 )$$

$${eAvgSide}_{i} = \frac{1}{n C} \frac{1}{F} {\sum }_{c = 0}^{n C - 1} {\sum }_{t = 0}^{F - 1} {{side}_{i} [ c , t ]}^{2} for nC > 2 \qquad ( Equation 11 )$$

$${eAvgSide}_{i} = \frac{1}{n C - 1} \frac{1}{F} {\sum }_{t = 0}^{F - 1} {{side}_{i} [ 0 , t ]}^{2} for nC = 2 \qquad ( Equation 12 )$$

Finally, a multichannel-mid to multichannel-side average energy relation ratio MSenRelᵢ is computed as:

$${MSenRel}_{i} = \frac{{eAvgSide}_{i}}{{eMid}_{i}} \qquad ( Equation 13 )$$

MSenRelᵢ will typically have the range [0.01 . . . 22.0]. The ratio MSenRelᵢ is now a low complex mid to average-side ratio which complements the dynamic range ratio dirᵢ in terms of identifying framewise variability among input channels in the spatial domain.

A score value for every frame i is then calculated as:

$${score}_{i} = {dir}_{i} * {MSenRel}_{i} . \qquad ( Equation 14 )$$

For frame i a scoreᵢ of 1.0 (0 dB) indicates a very dense signal and a scoreᵢ in the region of 120.0 (approx. 21 dB) indicates an extremely sparse signal.

If frame i's ratios dirᵢ*MSenRelᵢ in a logarithmic domain, the score calculation would be an additive process as shown in equation 15:

$${scoreDB}_{i} = {dirDB}_{i} + {en\_relDB}_{i} \qquad ( Equation 15 )$$

The next step is to calculate a total energy as:

$$total energy = {\sum }_{i = 0}^{Frames - 1} {energy}_{i} \qquad ( Equation 16 )$$

The total energy is used to normalize the frame-by-frame measures across the whole set of analyzed frames.

Next a relative energy is calculated as shown in equation 17:

$${relativeEnergy}_{i} = \frac{{energy}_{i}}{totalEnergy} \qquad ( Equation 17 )$$

The frame parameter relativeEnergyᵢ now normalizes the frame i's individual weight vs. all frames in the analyzed multichannel audio signal.

For each frame i an energy normalized score normScoreᵢ is produced by weighting the raw score scoreᵢ with the realtive energy relativeEnergyᵢ for the given frame as shown in equation 18:

$${normScore}_{i} = {score}_{i} * {relativeEnergy}_{i} \qquad ( Equation 18 )$$

Lastly, the spatial audio value, S, is calculated according to equation 19:

$$S = {\sum }_{i = 0}^{Frames - 1} ( {normScore}_{i} ) \qquad ( Equation 19 )$$

Once S is determined, S can be used to select one or more rendering options. In one embodiment, the rendering options is selected by comparing S to a threshold (denoted “SparseLim” or “SparseLimDB”). In one embodiment, SparseLim==20 and SparseLimDB=10*log10 (SparseLim)==13.01 dB. For example, if S≥SparseLim. the distanceGainModel parameter is set to 1, otherwise it is set to 0. Thus, in this example S is a spatial sparsity value where a value of S greater than SparseLim corresponds to a spatially sparse audio signal and a value of S less than SparseLim corresponds to a spatially dense audio signal. That is, the sum of the relative energy weighted scores is thresholded to obtain a sparse vs dense decision for the given audio file.

### Multiple Discrete Rendering Methods

For the case where more than two discrete rendering options are available the spatial audio value, S, may be split/quantized into a linear range. For example, for the case with three available distance gain models (dgm1, dgm2, dgm3), then the following logic can be used to select one of the three distance gain models: if S≤10, then select dgm1; else if S≤30, then select dgm2; else select dgm3.

That is, in general, the spatial audio value, S, may be quantized (essentially sectioned) into to a specific number of target rendering methods, based on a trained linear quantizer.

### Weighting Factor based Rendering Solution

To make it possible to smoothly go from one rendering behavior to another, one may smoothly transition between distance gain based rendering methods by using S to a select a weighting factor value, s_wfactor in the range 0.0 to 1.0, as follows:

$$s\_wfactor = min ( 1. , max ( 0.0 , S / 40 ) ) \qquad ( Equation 20 )$$

As an example, the final distance gain, g_{DistFinal}, may be calculated as

$${g}_{DistFinal} = s\_wfactor * {g}_{Dist 1} + ( 1 - s\_wfactor ) * {g}_{Dist 2} ,$$

where the final distance gain (g_{DistFinal}) is calculated as a weighted sum of g_{Dist1} and g_{Dist2}, which are the distance gains calculated with different distance gain models.

Real-time calculation of the spatial sparsity/density analysis:

In the case the input audio signal is changing over time and thus may contain a varying degree of sparsity it is beneficial to adaptively change which of the available rendering options are being used over time. There are two basic methodologies that are proposed be applied: (A) Sliding window analysis with a decision update every Nupd frames corresponding to a window width of Tupd (seconds) and (B) Continuous analysis with an update every frame.

(A) Sliding window analysis with a predetermined block/windows length.

With this real-time solution the audio input is analyzed over a time Tana (yielding Nana time samples per channel), possibly with an overlap of Toverlap (yielding Noverlap time samples per channel). Typically one would use Toverlap=Tana/2, to achieve a smooth update of the analyzed sparsity.

Basic example: Tana and Toverlap is, for example, 6 seconds and 3 seconds, respectively. The main benefit of this method is that the sparsity evaluation can be run as a lower priority background process and then be applied whenever ready. The drawback is that there will be delay due to the input signal windowing that will cause the rendering to be suboptimal (delayed application in the soud scene) for a short time. And further there will be a need to buffer the input signal features for the blockwise windowed analysis.

That is, with sliding windowed analysis the same equations as described by the preprocessing will be utilized, but run every Tupdate=Tana-Toverlap, and applied whenever the analysis processing is ready.

TABLE 3
Example timing for approach (A)

| | Sliding windows analysis | | | |
|---|---|---|---|---|
| | Tana = 6 sec | | | |
| | Tupd = Toverlap = 3 sec | | | |
| | Frame size 100 ms | | | |
| | Block length 30 frames | | | |
| | Block0 | Block1 | Block2 | Block3 |
| | 3 second | 3 second | 3 second | 3 second |
| | 30 frames | 30 frames | 30 frames | 30 frames |
| Update 0 | Tana = 6 seconds | | | |
| after 6 seconds | | | | |
| Update1 after | | Tana | | |
| after 9 seconds | | | | |
| Update 2 | | | Tana | |
| after 12 seconds | | | | |

(B) Continuous update (e.g. update the sparsity analysis at the same rate as the graphics engine produces new images e.g. in the range 30-90 Hz, or at the rate the sound environment update driver is operating e.g. 200Hz, 100Hz, 50 Hz, or 10 Hz)

To save storage of past frame values for (dirᵢ, and energyᵢ) it is preferable to apply autoregressive processes to estimate the long term features total energy (totalEnergy in the preprocessing solution) and past total accumulated scoresᵢ.

The previously defined storage and memory consuming implementation use the summation:

$$S = {\sum }_{i = 0}^{Frames - 1} ( {score}_{i} * {relativeEnergy}_{i} ) \qquad ( Equation 21 )$$

It may be represented by the dual memory efficient AutoRegressive order 1 (AR(1)) processes as follows:

First a running AR(1) estimate of the long term frame average energy is updated every frame as:

$${MeanEn}_{AR} ( i ) = α * {MeanEn}_{AR} ( i - 1 ) + ( 1 - α ) * {energy}_{i} \qquad ( Equation 22 )$$

with starting condition: MeanEn_{AR}(−1)=set to energy₀.

It was experimentally found for a frame size of 100 ms that:

$$α = \{ \begin{matrix}0.98 ; & i \geq {N}_{AR - init} \\ min ( 0.9 , ( 1. - \frac{1}{( i + 1 )} ) ) ; & i < {N}_{AR - init}\end{matrix} \qquad ( Equation 23 )$$

where i is the frame number starting from zero and N_{AR-init}=60 is an initialization frame limit corresponding to 6 second state initialization phase, this AR(1) setup yields a good estimator of the average frame energy:

$${relativeEnergy}_{AR} ( i ) = \frac{{energy}_{i}}{{N}_{AR - integration} * {MeanEn}_{AR} ( i )} \qquad ( Equation 24 )$$

where N_{AR-integration} is a total frame energy integration frame duration, e.g. N_{AR-integration} may be set to 80 to correspond to 8 second of energy integration for an SVD and Mid-Side analysis frame size of 100 ms. i.e. The product N_{AR-integration}*MeanEn_{AR}(i) corresponds the totalEnergy parameter in the preprocessing solution above, where the total energy is selected to correspond to roughly the last 8 seconds of the analyzed audio) normScore_{AR}(i)=β*normScore_{AR}(i−1)+(1−β)*scoreᵢ*relativeEnergy_{AR}(i) (Equation 25) with starting condition normScore_{AR}(−1)=set to score₀, and the AR(1) filter coefficient β is set according to:

$$β = \{ \begin{matrix}0.97 ; & i \geq {N}_{AR - init} \\ min ( 0.8 , ( 1. - \frac{1}{( i + 1 )} ) ) ; & i < {N}_{AR - init}\end{matrix} \qquad ( Equation 26 )$$

The resulting score normScore_{AR}(i) is then thresholded to obtain a binary discrete decision per frame for the spatial audio rendering methods as follows:

$$S = {N}_{AR - integration} * {normScore}_{AR} ( i ) \qquad ( Equation 27 )$$

$${spatiallyDense}_{AR} ( i ) = \{ \begin{matrix}0 ; & S \geq SparseLim \\ 1 ; & S < SparseLim\end{matrix} , \qquad ( Equation 28 )$$

where spatiallyDense_{AR}(i) is then used to control the rendering method for the current frame.

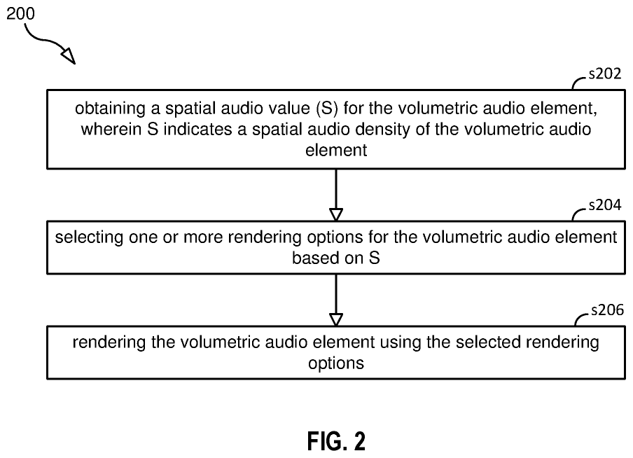

FIG. 2 is a flowchart illustrating a process 200, according to an embodiment, for rendering a volumetric audio element. Process 200 may begin in step s202. Step s202 comprises obtaining a spatial audio value, S, for the volumetric audio element, wherein S indicates a spatial audio density of the audio element. Step s204 comprises selecting one or more rendering options for the volumetric audio element based on S. Step s206 comprises rendering the volumetric audio element using the selected rendering options. In some embodiments, obtaining S comprises receiving metadata comprising S.

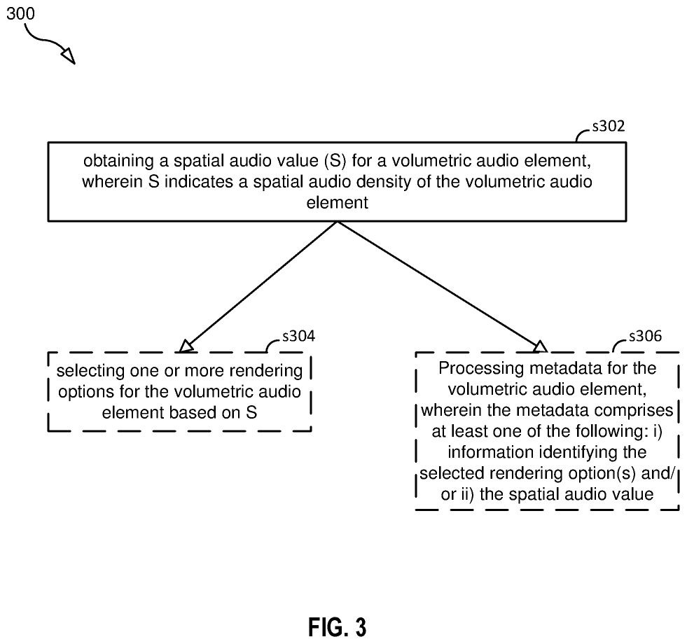

FIG. 3 is a flowchart illustrating a process 300, according to an embodiment, that is performed by encoder 102. Process 300 may begin in step s302. Step s302 comprises obtaining a spatial audio value, S, for a volumetric audio element, wherein S indicates a spatial audio density of the volumetric audio element. After step s302, step s304 and/or step s306 are performed. Step s304 comprises selecting one or more rendering options for the volumetric audio element based on S. Step s306 comprises processing metadata for the volumetric audio element (e.g., storing the metadata, transmitting the metadata, etc.), wherein the metadata comprises at least one of the following: i) information identifying the selected rendering option(s) and/or ii) the spatial audio value.

In some embodiments, obtaining S comprises calculating S using an audio signal for the volumetric audio element or a portion of the audio signal.

In some embodiments, the process comprises the processing step (step s306), the volumetric audio element has a spatial extent, and the metadata further comprises information indicating the spatial extent.

In some embodiments, the process comprises the selecting step (step s204 or s304), and one of said one or more selected rendering options is a distance gain model selected from a set of candidate distance gain models. In some embodiments, selecting a distance gain model comprises or consists of setting a distance gain model rendering parameter to a particular value that identifies the distance gain model. In some embodiments, selecting the distance gain model comprises: determining whether S satisfies a condition; and setting a distance gain model rendering parameter to a first value that identifies the distance gain model as a result of determining that S satisfies the condition. In some embodiments, determining whether S satisfies the condition comprises comparing S to a threshold.

In some embodiments, the process comprises the selecting step, and one of said one or more selected rendering options is a selected weighting factor value, s_wfactor.

In some embodiments, an audio signal for the for the volumetric audio element comprises at least a first set of audio frames, and obtaining S comprises: i) for each audio frame included in the first set of audio frames, calculating a normalized score for the audio frame and ii) summing said normalized scores to produce a sum, wherein S is equal to said sum. In some embodiments, calculating the normalized score for the audio frame comprises calculating a score for the audio frame and calculating a relative energy value for the audio frame, wherein the normative score is equal to the product of the score and the relative energy value.

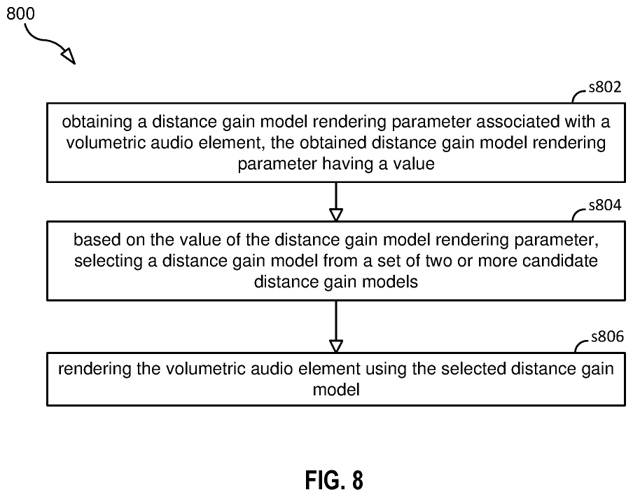

FIG. 8 is a flowchart illustrating a process 800, according to an embodiment, for rendering a audio element (e.g., a volumetric audio element) comprising two or more audio signals. Process 800 may begin in step s802. Step s802 comprises obtaining a distance gain model rendering parameter associated with a volumetric audio element, the obtained distance gain model rendering parameter having a value. Step s804 comprises, based on the value of the distance gain model rendering parameter, selecting a distance gain model from a set of two or more candidate distance gain models. Step s806 comprises rendering the volumetric audio element using the selected distance gain model.

In some embodiments, the value of the distance gain model rendering parameter was set based on an analysis of the two or more audio signals associated with the volumetric audio element.

In some embodiments process 800 also includes producing a spatial audio value, S, based on the analysis of the two or more audio signals; determining whether S satisfies a condition; and setting the distance gain model rendering parameter to the value as a result of determining that S satisfies the condition. In some embodiments, S indicates a spatial sparseness of the volumetric audio element.

In some embodiments, obtaining the distance gain model rendering parameter comprises obtaining metadata for the volumetric audio element, and the metadata comprises i) an volumetric audio element identifier that identifies the volumetric audio element and ii) the distance gain model rendering parameter. In some embodiments, the metadata further comprises a first diffuseness parameter indicating whether or not the metadata further includes a second diffuseness parameter. In some embodiments, the metadata further comprises a diffuseness parameter indicating a diffuseness of the volumetric audio element.

### Example Use Case

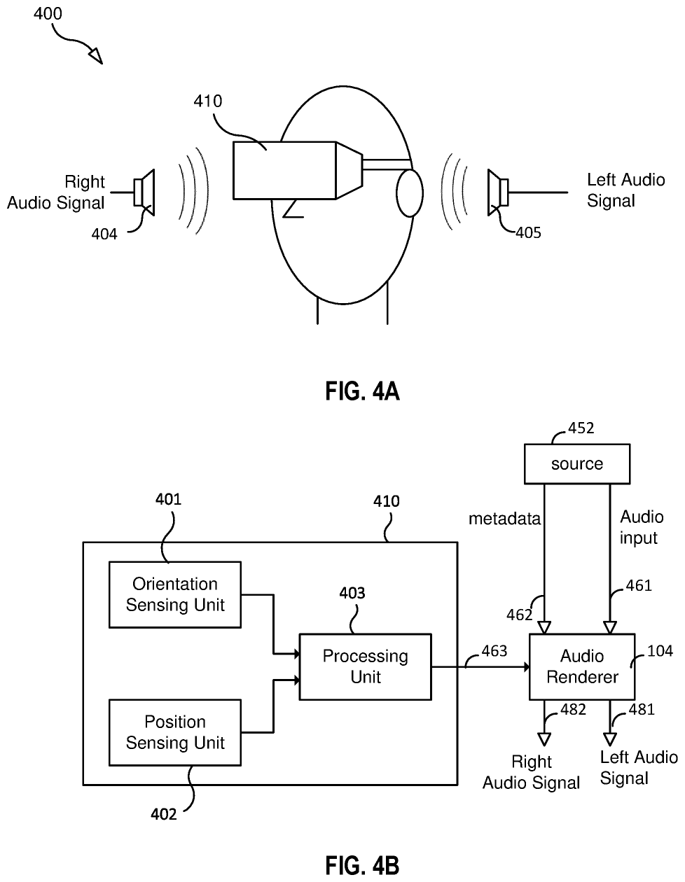

FIG. 4A illustrates an XR system 400 in which the embodiments disclosed herein may be applied. XR system 400 includes speakers 404 and 405 (which may be speakers of headphones worn by the listener) and an XR device 410 that may include a display for displaying images to the user and that, in some embodiments, is configured to be worn by the listener. In the illustrated XR system 400, XR device 410 has a display and is designed to be worn on the user's head and is commonly referred to as a head-mounted display (HMD).

As shown in FIG. 4B, XR device 410 may comprise an orientation sensing unit 401, a position sensing unit 402, and a processing unit 403 coupled (directly or indirectly) to audio render 104 for producing output audio signals (e.g., a left audio signal 481 for a left speaker and a right audio signal 482 for a right speaker as shown).

Orientation sensing unit 401 is configured to detect a change in the orientation of the listener and provides information regarding the detected change to processing unit 403. In some embodiments, processing unit 403 determines the absolute orientation (in relation to some coordinate system) given the detected change in orientation detected by orientation sensing unit 401. There could also be different systems for determination of orientation and position, e.g. a system using lighthouse trackers (lidar). In one embodiment, orientation sensing unit 401 may determine the absolute orientation (in relation to some coordinate system) given the detected change in orientation. In this case the processing unit 403 may simply multiplex the absolute orientation data from orientation sensing unit 401 and positional data from position sensing unit 402. In some embodiments, orientation sensing unit 401 may comprise one or more accelerometers and/or one or more gyroscopes.

Audio renderer 104 produces the audio output signals based on input audio signals 461, metadata 462 regarding the XR scene the listener is experiencing, and information 463 about the location and orientation of the listener. Input audio signals 461 and metadata 462 may come from a source 452 that may be remote from audio renderer 104 or that may be co-located with audio renderer. The metadata 462 for the XR scene may include metadata for each object and audio element included in the XR scene, and the metadata for a volumetric audio element may include information about the extent of the audio element and the rendering parameters discussed above (e.g., one or more parameters for controlling the distance gain model to be used for rendering the audio element). The metadata 462 for an object in the XR scene may also include control information, such as a reverberation time value, a reverberation level value, and/or an absorption parameter. Audio renderer 104 may be a component of XR device 410 or it may be remote from the XR device 410 (e.g., audio renderer 104, or components thereof, may be implemented in the so called “cloud”).

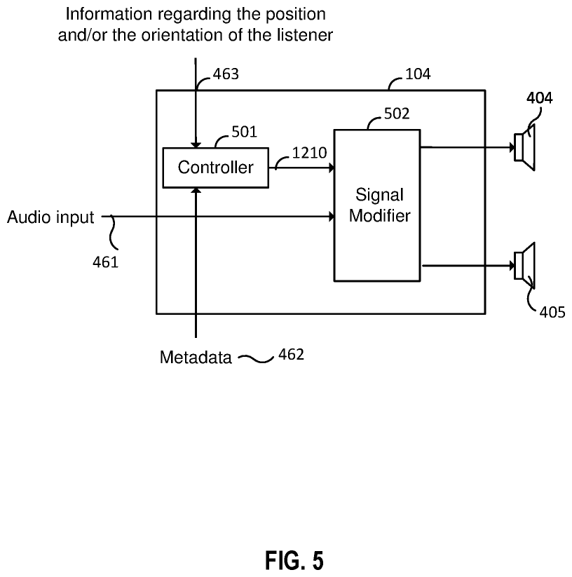

FIG. 5 shows an example implementation of audio renderer 104 for producing sound for the XR scene. Audio renderer 104 includes a controller 501 and a signal modifier 502 for modifying audio signal(s) 461 (e.g., the audio signals of a multi-channel volumetric audio element) based on control information 510 from controller 501. Controller 501 may be configured to receive one or more parameters and to trigger modifier 502 to perform modifications on audio signals 461 based on the received parameters (e.g., increasing or decreasing the volume level). The received parameters include information 463 regarding the position and/or orientation of the listener (e.g., direction and distance to an audio element) and metadata 462 regarding an audio element in the XR scene (in some embodiments, controller 501 itself produces the metadata 462 or a portion thereof). Using the metadata (e.g., one or more distance gain model control parameters) and position/orientation information, controller 501 may calculate one more gain factors (g) (a.k.a., attenuation factors) for an audio element in the XR scene.

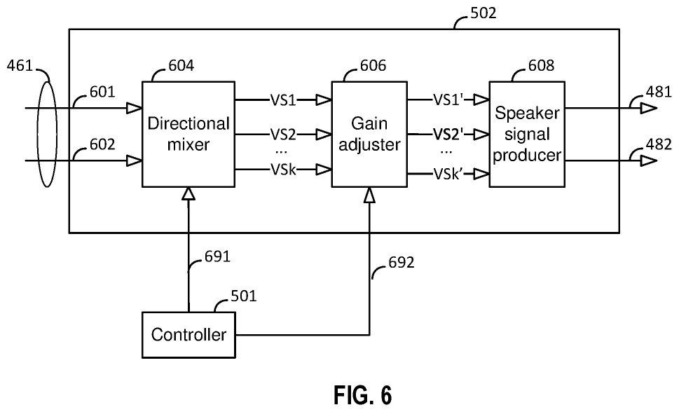

FIG. 6 shows an example implementation of signal modifier 502 according to one embodiment. Signal modifier 502 includes a directional mixer 604, a gain adjuster 606, and a speaker signal producer 608. Directional mixer receives audio input 461, which in this example includes a pair of audio signals 601 and 602 associated with an audio element, and produces a set of k virtual loudspeaker signals (VS1, VS2, . . . , VSk) based on the audio input and control information 691. In one embodiment, the signal for each virtual loudspeaker can be derived by, for example, the appropriate mixing of the signals that comprise the audio input 461. For example: VS1=α×L+β×R, where L is input audio signal 601, R is input audio signal 602, and a and B are factors that are dependent on, for example, the position of the listener relative to the audio element and the position of the virtual loudspeaker to which VS1 corresponds. Gain adjuster 606 may adjust the gain of any one or more of the virtual loudspeaker signals based on control information 692.

Using virtual loudspeaker signals VS1, VS2, . . . , VSk, speaker signal producer 608 produces output signals (e.g., output signal 481 and output signal 482) for driving speakers (e.g., headphone speakers or other speakers). In one embodiment where the speakers are headphone speakers, speaker signal producer 608 may perform conventional binaural rendering to produce the output signals. In embodiments where the speakers are not headphone speakers, speaker signal produce may perform conventional speaking panning to produce the output signals.

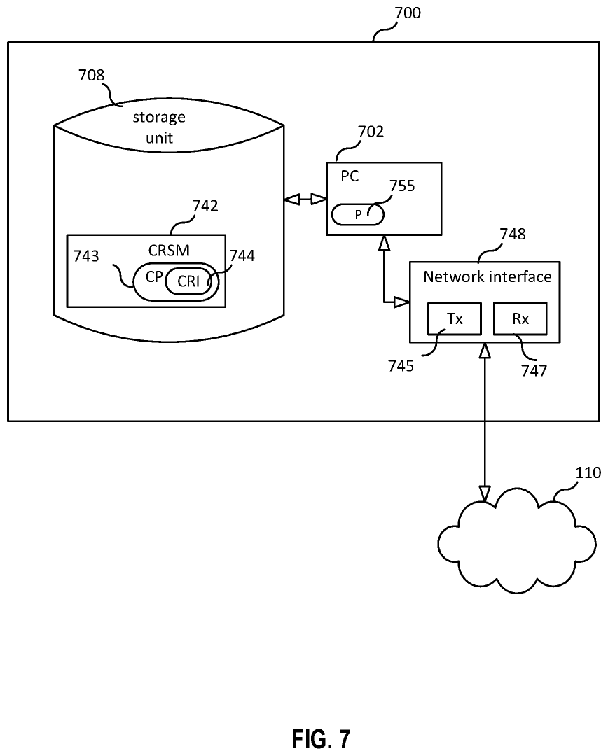

FIG. 7 is a block diagram of an apparatus 700, according to some embodiments, for performing any of the methods disclosed herein. When apparatus 700 is configured to perform the encoding methods (e.g., process 300) apparatus 700 may be referred to as an encoding apparatus; similarly when apparatus 700 is configured to perform the audio rending methods (e.g., process 200) apparatus 700 may be referred to as an audio rendering apparatus. As shown in FIG. 7, apparatus 700 may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 700 may be a distributed computing apparatus); at least one network interface 748 (e.g., a physical interface or air interface) comprising a transmitter (Tx) 745 and a receiver (Rx) 747 for enabling apparatus 700 to transmit data to and receive data from other nodes connected to a network 110 (e.g., an Internet Protocol (IP) network) to which network interface 748 is connected (physically or wirelessly) (e.g., network interface 748 may be coupled to an antenna arrangement comprising one or more antennas for enabling apparatus 700 to wirelessly transmit/receive data); and a storage unit (a.k.a., “data storage system”) 708, which may include one or more non-volatile storage devices and/or one or more volatile storage devices. In embodiments where PC 702 includes a programmable processor, a computer readable storage medium (CRSM) 742 may be provided. CRSM 742 may store a computer program (CP) 743 comprising computer readable instructions (CRI) 744. CRSM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes apparatus 700 to perform steps described herein (e.g., steps described herein with reference to the flow charts). In other embodiments, apparatus 700 may be configured to perform steps described herein without the need for code. That is, for example, PC 702 may consist merely of one or more ASICs. Hence, the features of the embodiments described herein may be implemented in hardware and/or software.

### Summary of Various Embodiments

A1. A method 200 for rendering a volumetric audio element, comprising: obtaining a spatial audio value, S, for the volumetric audio element, wherein S indicates a spatial audio density of the audio element; selecting one or more rendering options for the volumetric audio element based on the obtained spatial audio value; and rendering the volumetric audio element using the selected rendering option(s).

A2. The method of embodiment A1, wherein obtaining S comprises calculating S using an audio signal for the volumetric audio element or a portion of the audio signal.

A3. The method of embodiment A1, wherein obtaining S comprises receiving metadata comprising S.

A4. The method of any one of embodiments A1-A3, wherein one of said one or more selected rendering options is a distance gain model selected from a set of candidate distance gain models.

A5. The method of embodiment A4, wherein selecting a distance gain model comprises or consists of setting a distance gain model rendering parameter to a particular value that identifies the distance gain model.

A6. The method of embodiment A4, wherein selecting the distance gain model comprises: determining whether S satisfies a condition; and setting a distance gain model rendering parameter to a first value that identifies the distance gain model as a result of determining that S satisfies the condition.

A7. The method of embodiment A6, wherein determining whether S satisfies the condition comprises comparing S to a threshold.

A8. The method of any one of embodiments A1-A7, wherein one of said one or more selected rendering options is a selected weighting factor value, s_wfactor.

A9. The method any one of embodiments A1-A8, wherein an audio signal for the for the volumetric audio element comprises at least a first set of audio frames, and obtaining S comprises: i) for each audio frame included in the first set of audio frames, calculating a normalized score for the audio frame and ii) summing said normalized scores to produce a sum, wherein S is equal to said sum.

A10. The method of embodiment A9, wherein calculating the normalized score for the audio frame comprises calculating a score for the audio frame and calculating a relative energy value for the audio frame, wherein the normative score is equal to the product of the score and the relative energy value.

B1. A method 300 performed by an encoder, comprising: obtaining a spatial audio value, S, for a volumetric audio element, wherein S indicates a spatial audio density of the audio element; and performing at least one of the following: selecting one or more rendering options for the volumetric audio element based on the obtained spatial audio value; or processing metadata for the volumetric audio element (e.g., storing the metadata, transmitting the metadata, etc.), wherein the metadata comprises at least one of the following: i) information identifying the selected rendering option(s) and/or ii) the spatial audio value.

B2. The method of embodiment B1, wherein obtaining S comprises calculating S using an audio signal for the volumetric audio element or a portion of the audio signal.

B3. The method of any one of embodiments B1-B2, wherein the method comprises the metadata processing step, the volumetric audio element has a spatial extent, and the metadata further comprises information indicating the spatial extent.

B4. The method of any one of embodiments B1-B3, wherein the method comprises the selecting step, and one of said one or more selected rendering options is a distance gain model selected from a set of candidate distance gain models.

B5. The method of embodiment B4, wherein selecting a distance gain model comprises or consists of setting a distance gain model rendering parameter to a particular value that identifies the distance gain model.

B6. The method of embodiment B4, wherein selecting the distance gain model comprises: determining whether S satisfies a condition; and setting a distance gain model rendering parameter to a first value that identifies the distance gain model as a result of determining that S satisfies the condition.

B7. The method of embodiment B6, wherein determining whether S satisfies the condition comprises comparing S to a threshold.

B8. The method of any one of embodiments B1-B7, wherein the method comprises the selecting step, and one of said one or more selected rendering options is a selected weighting factor value, s_wfactor.

B9. The method any one of embodiments B1-B8, wherein an audio signal for the for the volumetric audio element comprises at least a first set of audio frames, and obtaining S comprises: i) for each audio frame included in the first set of audio frames, calculating a normalized score for the audio frame and ii) summing said normalized scores to produce a sum, wherein S is equal to said sum.

B10. The method of embodiment B9, wherein calculating the normalized score for the audio frame comprises calculating a score for the audio frame and calculating a relative energy value for the audio frame, wherein the normative score is equal to the product of the score and the relative energy value.

C1. A computer program 743 comprising instructions 744 which when executed by processing circuitry 702 of an apparatus 700 causes the apparatus to perform the method of any one of the above embodiments.

C2. A carrier containing the computer program of embodiment C1, wherein the carrier is one of an electronic signal, an optical signal, a radio signal, and a computer readable storage medium 742.

D1. An apparatus 700 that is configured to perform the method of any one of the above embodiments.

D2. The apparatus of embodiment D1, wherein the apparatus comprises memory 742 and processing circuitry 702 coupled to the memory.

While various embodiments are described herein, it should be understood that they have been presented by way of example only, and not limitation. Thus, the breadth and scope of this disclosure should not be limited by any of the above described exemplary embodiments. Moreover, any combination of the above-described objects in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] MPEG-H 3D Audio, ISO/IEC 23008-3: 201x(E)

[2] EBU Tech 3388, “ADM Renderer for use in Next Generation Audio Broadcasting,” BTF Renderer Group, Specification Version 1.0, Geneva, March 2018.

[3] Efficient HRTF-based Spatial Audio for Area and Volumetric Sources”, IEEE Transactions on Visualization and Computer Graphics 22(4): 1-1, January 2016.

[4] Patent Publication WO2020144062, “Efficient spatially-heterogeneous audio elements for Virtual Reality.”

[5] Patent Publication WO2021180820, “Rendering of Audio Objects with a Complex Shape.”

[6] Patent Publication WO2022017594, “SPATIAL EXTENT MODELING FOR VOLUMETRIC AUDIO SOURCES.”

[7] Patent Publication WO2021121698, “AUDIO RENDERING OF AUDIO SOURCES.”

1. A method for rendering a volumetric audio element comprising two or more audio signals, the method comprising:
obtaining a distance gain model rendering parameter associated with the volumetric audio element, the obtained distance gain model rendering parameter having a value;
based on the value of the distance gain model rendering parameter, selecting a distance gain model from a set of two or more candidate distance gain models; and
rendering the volumetric audio element using the selected distance gain model.

2. The method of claim 1, wherein
the value of the distance gain model rendering parameter was set based on an analysis of the two or more audio signals associated with the volumetric audio element.

3. The method of claim 2, further comprising:
producing a spatial audio value, S, based on the analysis of the two or more audio signals;
determining whether S satisfies a condition; and
setting the distance gain model rendering parameter to the value as a result of determining that S satisfies the condition.

4. The method of claim 3, wherein S indicates a spatial sparseness of the volumetric audio element.

5. The method of claim 1, wherein
obtaining the distance gain model rendering parameter comprises obtaining metadata for the volumetric audio element, and
the metadata comprises i) an audio element identifier that identifies the audio element and ii) the distance gain model rendering parameter.

6. The method of claim 5, wherein the metadata further comprises a first diffuseness parameter indicating whether or not the metadata further includes a second diffuseness parameter.

7. The method of claim 5, wherein the metadata further comprises a diffuseness parameter indicating a diffuseness of the volumetric audio element.

8. A method for rendering a volumetric audio element, comprising:
obtaining a spatial audio value, S, for the volumetric audio element, wherein S indicates a spatial audio density of the volumetric audio element;
selecting one or more rendering options for the volumetric audio element based on the obtained spatial audio value; and
rendering the volumetric audio element using the selected rendering option(s).

9-17. (canceled)

18. A method performed by an encoder, comprising:
obtaining a spatial audio value, S, for a volumetric audio element, wherein S indicates a spatial audio density of the audio element; and
performing at least one of the following:
selecting one or more rendering options for the volumetric audio element based on the obtained spatial audio value; or
processing metadata for the volumetric audio element, wherein the metadata comprises at least one of the following: i) information identifying the selected rendering option(s) and/or ii) the spatial audio value.

19. The method of claim 18, wherein obtaining S comprises calculating S using an audio signal for the volumetric audio element or a portion of the audio signal.

20. The method of claim 18, wherein
the method comprises the metadata processing step,
the volumetric audio element has a spatial extent, and
the metadata further comprises information indicating the spatial extent.

21. The method of claim 18, wherein
the method comprises the selecting step, and
one of said one or more selected rendering options is a distance gain model selected from a set of candidate distance gain models.

22. The method of claim 21, wherein selecting a distance gain model comprises or consists of setting a distance gain model rendering parameter to a particular value that identifies the distance gain model.

23. The method of claim 21, wherein selecting the distance gain model comprises:
determining whether S satisfies a condition; and
setting a distance gain model rendering parameter to a first value that identifies the distance gain model as a result of determining that S satisfies the condition.

24. The method of claim 23, wherein determining whether S satisfies the condition comprises comparing S to a threshold.

25. The method of claim 18, wherein
the method comprises the selecting step, and
one of said one or more selected rendering options is a selected weighting factor value, s_wfactor.

26. The method of claim 18, wherein
an audio signal for the for the volumetric audio element comprises at least a first set of audio frames, and
obtaining S comprises: i) for each audio frame included in the first set of audio frames, calculating a normalized score for the audio frame and ii) summing said normalized scores to produce a sum, wherein S is equal to said sum.

27. The method of claim 26, wherein calculating the normalized score for the audio frame comprises calculating a score for the audio frame and calculating a relative energy value for the audio frame, wherein the normative score is equal to the product of the score and the relative energy value.

28-29. (canceled)

30. An apparatus for rendering an audio element comprising two or more audio signals, the apparatus being configured to perform a method comprising:
obtaining a distance gain model rendering parameter associated with the audio element, the obtained distance gain model rendering parameter having a value;
based on the value of the distance gain model rendering parameter, selecting a distance gain model from a set of two or more candidate distance gain models; and
rendering the audio element using the selected distance gain model.

31. (canceled)

32. An apparatus for rendering a volumetric audio element, the apparatus being configured to perform a method comprising:
obtaining a spatial audio value, S, for the volumetric audio element, wherein S indicates a spatial audio density of the volumetric audio element;
selecting one or more rendering options for the volumetric audio element based on the obtained spatial audio value; and
rendering the volumetric audio element using the selected rendering option(s).

33. (canceled)

34. An encoding apparatus, the encoding apparatus being configured to perform a method comprising:
obtaining a spatial audio value, S, for a volumetric audio element, wherein S indicates a spatial audio density of the audio element; and
performing at least one of the following:
selecting one or more rendering options for the volumetric audio element based on the obtained spatial audio value; or
processing metadata for the volumetric audio element, wherein the metadata comprises at least one of the following: i) information identifying the selected rendering option(s) and/or ii) the spatial audio value.

35. (canceled)
